(19) United States
(12) Patent Application Publication
(10) Pub. No.: US 2009/0321515 A1
(43) Pub. Date: Dec. 31, 2009

(54) Vending Machine for Alcohol with Means to Verify

(76) Inventor: Michael Jeffrey Turner, Edmond, OK (US)

Correspondence Address: A PATENT LAWYER CORP, PLC;R WILLIAM GRAHAM, 22 S ST CLAIR ST, DAYTON, OH, 45402, US

(21) Appl. No.: 12/164,042

(22) Filed: Jun. 28, 2008

(51) Int. Cl. G06F 7/08

(52) U.S. Cl. 235/381

(57) ABSTRACT

A system for a vending machine for alcoholic or restricted items is equipped to verify the legality of the transaction through the acceptance of driver licenses through use of electronic means to scan and temporarily store age, height, gender, and weight, picture and other biometric data such as but not limited to fingerprint with the intent and purpose of using such biometric data to verify that the user is purchasing the restricted item through the application of facial recognition software or but not limited to fingerprint scanning or other secondary verification processes.

### BACKGROUND OF INVENTION

1. Field of Invention

The present invention relates generally to a vending machine for vending age-restricted products using a government issued identification such as a driver license and various electronic and biometric means to verify that the driver license and the customer matches the license.

2. Related Art

Most, if not all, states impose minimum age requirements for the purchase of certain products such as alcoholic beverages, tobacco products, pornographic material, and other age-limited items. In order to purchase such products, the customer traditionally must present identification to the seller to verify his or her age prior to the transaction. The lack of means to verify the customer's age prevents age-restricted products from being sold in vending machines.

This problem is compounded when the use of illegal misrepresented driver licenses are employed to seek these age-limited items. Further problems exist when alcoholic products are being purchased. Some laws exist to where the consumer may not become too intoxicated, and many laws regulate the level of alcohol tolerable as a percentage present in a person's blood stream before becoming too intoxicated legally to laws that limit and specify location of alcohol consumption.

This verification process is problematic in the vending machine industry since vending machines involve unattended at-site transactions. An example of prior approaches to this problem or related problems can be found in the following U.S. patents. U.S. Pat. No. 6,792,334 issued to Metcalf provides a vending machine system for age-restricted products. In the Metcalf system, a customer is issued an authorization card when they have been deemed legal. Thereafter, the customer is prompted to input the authorization card and input a passkey. Upon verification of the passkey, an age-limited item may be vended. If ambiguity exists, secondary means to authenticate are required, such as a credit card. U.S. Pat. No. 6,854,642 issued to Metcalf teaches a system in which the use of assumed legal identification is accepted as well as a credit card or alternate assumed legal identification to allow a transaction to occur.

However, the possible requirement of needing a secondary means of authentication as taught by Metcalf itself is easily foiled by a legal adult lending an underage friend their ID, a password and a credit card or debit card. Thus, while Metcalf attempts to solve the problem of providing such age restricted items through vending, there is a need to improve the art with a better real time verification system. Accordingly, the instant invention provides such improvement over the art.

### BRIEF SUMMARY OF INVENTION

The invention meets the above needs and overcomes the inadequacies of the prior art by providing an economically feasible and commercially viable method and system for verifying the age of a purchaser prior to his purchase of age-restricted items from a vending machine. Most common forms of driver licenses, and especially the potential future driver license known as the Real ID being touted by the U.S. Government to states, there exists a bar code or magnetic means for the data within the driver license to be read by a machine. Many states subsequently have databases which have on file that particular identification card to verify that that particular bar code sequence exists, matches the card in question, and has further fingerprint or other biometric data available to be used for comparison. In light of the technological strides being taken by the federal and state governments for the use of anti-terrorism policies, security measures have become very advanced. In particular interest for economic viability, the use of statistics in combination with known transactions and the gleaned facts revealed through identification card input would be of particular use to marketing and anti binge drinking initiatives and to allow better serving of customers.

The possible requirement of needing a secondary means of authentication as taught by the instant invention overcomes the potential of unauthorized use of an ID card, credit card or debit card. Particularly, the ubiquitous deployment of biometrics in many high-security environments and vast communication of current and future electronic devices means aid in overcoming the shortcomings of having a potentially fraudulent transaction. Another problem of age-limited items being vended is ease of deployment and efficiency of use by the customer.

The goal for a vending machine is to be fast and efficient, especially in regards to a keenly deployed alcoholic vending machine, i.e. in a bar, kiosk, or at a large sporting event where a patron may be tired of waiting in line at a conventional counter. The notion of having to obtain a pass card and/or requiring multiple cards and passkey interface in addition to payment means does not allow a quick vending experience.

It would therefore be advantageous to have a vending machine capable of vending age-restricted products that did not suffer from the drawbacks of the prior art. Further, establishments or companies owning such machines may enjoy a better legal ground under safe harbor laws provided by the instant invention.

Accordingly, one aspect of the invention is directed to a vending system for proper vending of age-restricted items. The system includes an apparatus for vending an age-restricted item, a data obtaining device operably associated with the apparatus for obtaining personalized data from a user's government issued identification card and a verifying device for verifying the personalized data and determining the legality of a transaction.

A user presents the identification card such that it is read to capture age and store the pertinent data, whereupon the authenticity of the identification is ascertained, typically through a quick check to see if the barcode is legal and working. The vending system can be equipped with at-site device for obtaining biometric data, either a digital picture or fingerprint, for example. The verifying device can be equipped to communicate with a database, such as a government database, to verify the biometric data by analyzing the newly obtained biometric data to the authenticated identification card. The analysis will determine if the customer is then allowed to purchase from the vending machine. The customer then chooses his age-restricted item through the available options and can provide a payment card via a conventional swipe card device operably associated with the vending system to allow quick vending.

### BRIEF DESCRIPTION OF DRAWINGS

FIG. 1 is a black box perspective of the invention.

FIG. 2 is another black box of another embodiment of the invention.

FIG. 3 is still another black box of another embodiment of the invention.

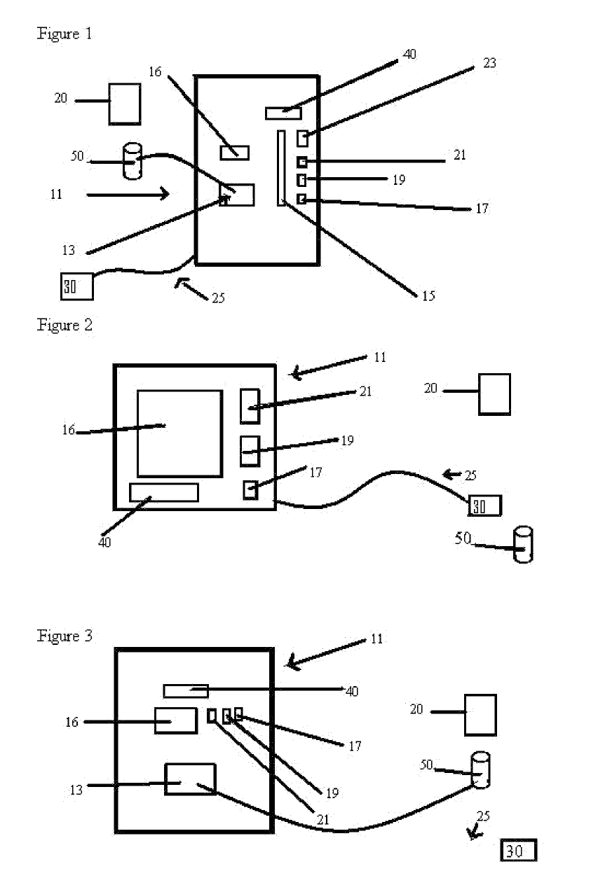

### DETAILED DESCRIPTION OF THE INVENTION

Referring now to the drawings, a vending system of the present invention is generally represented by the numeral 11. The vending system 11 is envisioned to cover several embodiments having common features included. The vending system 11 can include user input 15 such as a punch button technology or could also include a touch input screen 16, for example, which is operably associated with control software on a computer based system 40. The vending system 11 can optionally include a status display 23 to help the user understand the state of the transaction, i.e. whether to insert payment, identification or biometric input among other things. The screen 16 can be operably disposed at any suitable location, such as adjacent a table or a bar within an establishment and at an appropriate level, height. The system 11 can be equipped with a government identification card reader 19 for obtaining data from a government identification card 20 and transmitting a signal corresponding to the data thereon to the computer based system 40, which can further transmit a signal over the communication connection 25 to remote computer based servers 30 having databases in an appropriate fashion.

An on-site biometric obtaining device 17 can be operably associated with the computer based system 40. In use, a user will be typically prompted through the screen 16 to insert his/her government identification card 20 whereupon the user then inputs the government identification card 20. When the government identification card 20 has been input, the computer based system 40 confers internally and/or through an external communication port 25, i.e. connection to server 30, with a database having government data pertaining and corresponding to the government identification card 20 in order to determine the veracity and authenticity of supplied government identification card 20.

Also after input, the computer based system 40 through the screen 16 can then prompt for either a fingerprint input or a facial/physical recognition input via a camera, or a combination of the biometric input manners which are obtained through the biometric obtaining device 17. Following biometric data being received, a comparison and analysis of data on card 20 and biometrical data is performed by the based system 40. Assuming the user has proceeded to pass the required steps and is of sufficient legal age for age-restricted item 50, a user determined item received via touch screen input 16 can proceed to be vended through a typical item receptacle 13 upon receiving of payment through a payment mechanism 21 as currently known to the art.

An alternate embodiment, FIG. 2, of the vending system 11 is envisioned to cover several embodiments having common features included. The vending system 11 includes a touch input screen 16 which is operably associated with control software on a computer based system 40. The screen 16 can be operably disposed at any suitable location, such as adjacent a table or a within the vending system 11 itself to maintain compact size. The system 11 can be equipped with a government identification card reader 19 for obtaining data from a government identification card 20 and transmitting a signal corresponding to the data to the computer based system 40, which can further transmit a signal over the communication connection 25 to outside services 30 in an appropriate fashion.

An on-site biometric obtaining device 17 can be operably associated with the computer based system 40. In use, a user will be typically prompted through the screen 16 to insert his/her government identification card 20 whereupon the user then inputs the government identification card 20. When the government identification card 20 has been input, the computer based system 40 confers internally and/or through an external communication port 25, i.e. connection to a server 30 with a database having government data pertaining and corresponding to the government identification card 20 in order to determine the veracity and authenticity of supplied government identification card 20.

Also after input, the computer based system 40 through the screen 16 then prompts for either a fingerprint input or a facial/physical recognition input via a camera, or a combination of the biometric input manners which are obtained through the biometric obtaining device 17. Following biometric data being received, a comparison and analysis of data is similarly performed by the computer based system 40. Assuming the user has proceeded to pass the required steps and is of sufficient legal age for age-restricted item 50, a user determined item received via touch screen input 16 can proceed to be vended from an external source through a transmitting of signal over the communication connection 25 to a device such as another computer located appropriately whereupon the customer defined age-restricted item 50 is displayed on another screen and then brought to the customer after notice of such a transmitted signal, upon receiving of payment through a payment mechanism 21 as currently known to the art.

In yet another embodiment, FIG. 3, of the vending system 11 is envisioned to cover several embodiments having common features included. The vending system 11 includes a touch input screen 16 which is operably associated with control software on a computer based system 40. The screen 16 can be operably disposed at any suitable location, such as adjacent a table or a within the vending system 11 itself to maintain compact size. The system 11 can be equipped with a government identification card reader 19 for obtaining data from a government identification card 20 and transmitting a signal corresponding to the data to the computer based system 40, which can further transmit a signal over the communication connection 25 to outside computers 30 in an appropriate fashion.

An on-site biometric obtaining device 17 can be operably associated with the computer based system 40. In use, a user will be typically prompted through the screen 16 to insert his/her government identification card 20 whereupon the user then inputs the government identification card 20. When the government identification card 20 has been input, the computer based system 40 confers internally and/or through an external communication port 25, i.e. connection to a server 30 with a database having government data pertaining and corresponding to the government identification card 20 in order to determine the veracity and authenticity of supplied government identification card 20.

Also after input, the computer based system 40 through the screen 16 then prompts for either a fingerprint input or a facial/physical recognition input via a camera, or a combination of the biometric input manners which are obtained through the biometric obtaining device 17. Following biometric data being received, a comparison and analysis of data is likewise performed by the based system 40. Assuming the user has proceeded to pass the required steps and is of sufficient legal age for age-restricted item 50, a user determined item received via touch screen input 16 can proceed to be vended from within the vending system 11 through the product receptacle 13, upon receiving of payment through a payment mechanism 21 as currently known to the art. The communication connection 25 serves to operably connect the computer 40 of the system 11 to an outside device 30 similar thereof to allow transmitting of signal of the status of the system 11.

While the present invention has been set forth above in a preferred embodiment, it is contemplated that other modifications, improvements and derivations will be readily apparent to those skilled in the art. For example, it is contemplated that the age restricted items could be created or mixed within the vending machine as seen in an analogous coffee vending machine with a touch screen interface to dictate the desired components and cost. Alternate versions may be where a remote vend is occurred, wherein outline and similar concepts of vending machines with external communication mechanisms are able to transmit age-restricted item orders to a location with the knowledge that the order has been verified as a legal transaction and the age restricted item is then brought out, removing the vending portion but maintaining a similar overall functionality of “remote vending.” Accordingly, the appended claims hereto should be accorded the full scope of protection of any such modifications, improvements and derivations.

What is claimed is:

1. A vending system for proper vending of age-restricted items, which includes:
an apparatus for vending an age- restricted item;
data obtaining means operably associated with the apparatus for obtaining personalized data from a user's government issued identification card; and
verifying means for verifying said personalized data and determining legality of a transaction.

2. The vending system of claim 1, wherein said data obtaining means includes biometric comparison analysis device for analyzing a biometric characteristic of the user with said personalized data.

3. The vending system of claim 1, wherein said vending system includes means for restricting items contained therein to a user having a threshold age.

4. The vending system of claim 1, wherein said vending system includes means for accepting payment.

5. The vending system of claim 1, wherein said data obtaining means includes an electronic bar code scanner.

6. The vending system of claim 1, wherein said data obtaining means includes an optical scanner for reading said data.

7. The vending system of claim 2, wherein said system is equipped for comparing physical biological attributes of the user with said personalized data.

8. The vending system of claim 7, wherein said system is equipped for comparing a fingerprint with said personalized data.

9. The vending system of claim 7, wherein said system is equipped for performing facial recognition by comparing a user face with said personalized data.

10. The vending system of claim 1, wherein said system is equipped with a touch screen interface.

11. The vending system of claim 1, wherein said system is equipped for transmitting and receiving electronic signals for the purposes of communicating data to external systems.

12. The vending system of claim 1, wherein said system is equipped for performing statistical analysis of transactions performed through said system.
